(19) United States
(12) Patent Application Publication
(10) Pub. No.: US 2003/0230889 A1
(43) Pub. Date: Dec. 18, 2003

(54) Bible binder

(76) Inventor: Darrell Cole, Houston, TX (US)

Correspondence Address: KENNETH D. BAUGH, 2413 Blodgett, Houston, TX, 77004, US

(21) Appl. No.: 10/171,301

(22) Filed: Jun. 17, 2002

(51) Int. Cl. B42D 3/00

(52) U.S. Cl. 281/31

(57) ABSTRACT

A binder 10 in accordance with the principles of this invention is provided for supporting a bible 12 therein. The binder 10 includes a front support member 14 and a lower back support member 16 hingedly aligned with and spaced from the front support member. A first pocket member 24 is formed on the front support member 14 for supporting a front cover of the bible 12 therein, and a second pocket member 32 is formed on the back support member 16 for supporting a back cover of the bible therein. A spaced vertically extending pocket member 44 is provided on the front support member 14, which includes written indicia, which represents a chronological illustration of the books of the bible

The binder 10 is further provided with a third pocket member 58, which is formed on an upper portion of the front support member 14, and a fourth pocket member 62 formed below the third pocket member A triangular shaped pocket member 74 is provided on the back support member 16 on lowermost portions thereof The binder 10 is also provided with an intermediate support member 80, which is pivotally coupled to outermost portions of the back support member 16. A fifth pocket member 90 is provided on the intermediate support member 80. The binder 10 is also provided with an elongated horizontally extending support member 96 having an opening 98 formed therethrough on an uppermost portion of the intermediate support member 80.

### TECHINAL FIELD

This invention relates to bookbinders and more particularly to a bible bookbinder. For as long as we can remember binders have served as a support container for carrying all sorts of books. The popularity and practically of the binder is well known As a result you now have binders that can be used for just about all kinds of books However more and more there is a need for a binder that can be readily used too enhance the users everyday bible studies and worship experience. To achieve this the user should have ready access to those tools and supporting materials that enhance the experience The binder for this environment should be versatile and allow the user to carry the bible as well as other supporting study tools and materials. Accordingly, a binder is needed that is versatile while still durable and inexpensive enough to make it practical for a user to own

### BACKGROUND OF THE ART

Attempts have been made to provide binders that are desirable which can also satisfy the various needs of a user One such binder is disclosed in U.S. Pat. No. 6,045,160. This binder is a binder for holding articles such as a bible or other religious text, note pads, and tracts in pockets disposed on the outside surface of the front and back cover The device includes a front cover and a back cover hingedly attached to a spine, a plurality of open-ended sleeves hingedly attached to the spine between the front and back covers, and at least a first pocket disposed upon a front cover outside surface. Although this binder provides some versatility there is still a need for a binder which is designed to allow a student of the bible to have the maximum number of bible study tools and other materials in one convenient binder

Another arrangement is disclosed in U.S. Pat. No. 6,045,159. The holder of this invention comprises a stiff flat member creased to provide a central stationary panel corresponding to the spine of the book and a pair of pivotal panels corresponding to the front and back of the book. A spring assembly comprises a plurality of long concave thin metal members connected together by a strip of tape and connected to the stiff flat member by a pop rivet. The ends of the spring are received by a pair of plastic sleeves, which are stitched to the flat member. The stiff flat member is covered by a vinyl sheet in such a way as to have a curved edge providing a radius of at least 1/16-inch. A transparent strap connects to the opposite sides of the book holder and presses open pages of the book against the flat stiff member. The curved edge prevents the transparent straps from being cut by the book holder Although this binder provides a sturdy enclosure for the book itself this arrangement does not accommodate the additional tools and materials needed to enhance the bible study and worship experience.

These arrangements are suitable for the purpose intended. However there is still a need for an inexpensive but durable book binder that will allow a user to carry the bible and all of the accessories and study materials that may be desired to make for an enjoyable experience

### DISCLOSURE OF THE INVENTION

A binder for supporting a bible therein in accordance with the principles of this invention is provided with a front support member and a lower back support member aligned with and spaced from the front support member. A vertically extending coupling member is aligned between the front and back members to hingedly couple the front and back support members together A first pocket member is formed on the front support member for supporting a front cover of the bible therein. A second pocket member is formed on the back support member for supporting a back cover of the bible therein A spaced vertically extending pocket member is provided on the front support member which includes written indicia representing a chronological illustration of the books of the bible. The binder is further provided with a third pocket member which is formed on an upper portion of the front support member A fourth pocket member is formed below the third pocket member on a lower portion of the first support member

A triangular shaped pocket is provided on the back support member in alignment with lowermost portions thereof. The binder is also provided with an intermediate support member which is pivotally coupled to outermost portions of the back support member. A fifth pocket member is provided on the intermediate support member. The binder is also provided with a horizontally extending support member having an opening formed therethrough on an uppermost portion of the intermediate support member.

### BRIEF DESCRIPTION OF THE INVENTION

The details of the invention will be described in connection with the accompanying drawing in which.

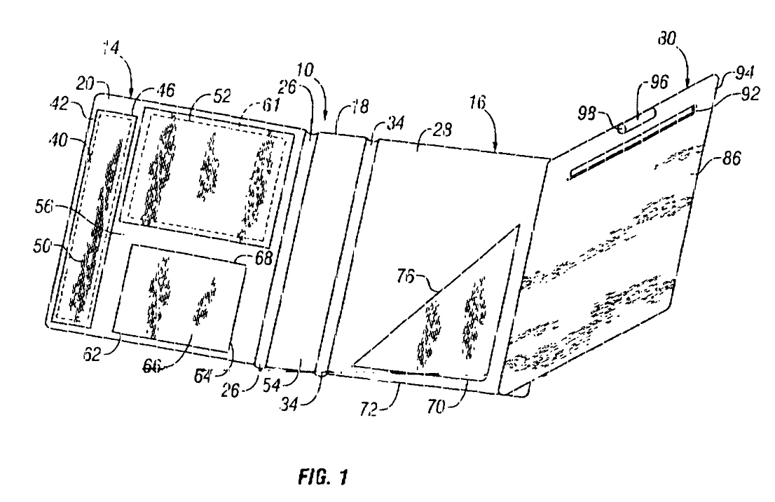

FIG. 1 is a perspective view illustrating a binder in accordance with the principles of the invention

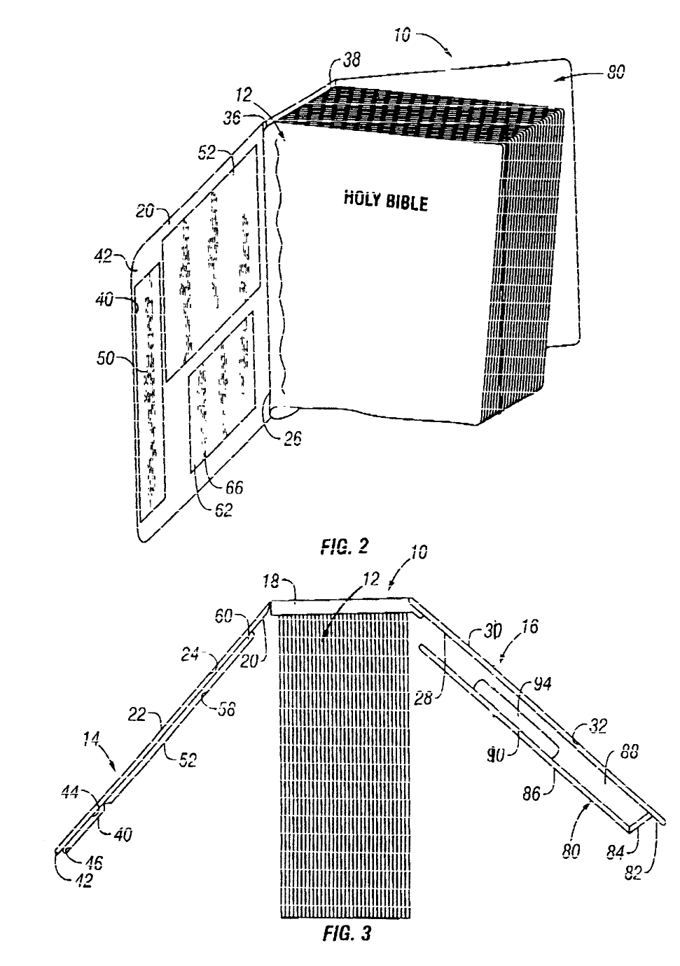

FIG. 2 is a perspective view illustrating a binder having a bible supported therein in accordance with the principles of the invention

FIG. 3 is a top view of FIG. 2 illustrating a binder in accordance with the principles of the invention

### BEST MODE FOR CARRYING OUT THE INVENTION

Referring to FIGS. 1, 2 and 3 a binder, generally designated, by the numeral, 10 is provided to hold and support a bible 12 (FIG. 2) therein. The binder 10 includes a front support member, generally designated, by the numeral 14 and a back support member, generally designated, by the numeral 16 A vertically extending coupling member 18 is aligned between the front and back support members to hingedly couple the front and back support members in spaced alignment with each other

The front support member 14 is provided with a first upper planar member 20 and a lower planar member 22 The planar members 20 and 22 are coupled together in adjacent spaced alignment so that a pocket member 24 (FIG. 3) is formed therebetween having a vertically extending access opening 26 formed therein adjacent to the vertically extending coupling member 18

The back support member 16 is provided with upper and lower spaced aligned planar members 28 and 30 respectively. The planar members 28 and 30 are coupled together so that a pocket member 32 is formed therebetween having a vertically extending access opening 34 formed adjacent to the vertically extending coupling member 18. The pocket members 24 and 32 are provided so that front and back covers 36 and 38 respectively of the bible can be inserted in the adjacently aligned pockets so that the bible 12 is supported in the binder.

The binder 10 is also provided with a vertically extending planar member 40 The vertically extending planar member 40 is spaced from and coupled to outermost portions 42 of the first upper planar member 20 of the front support member 14 so that a vertically extending pocket member 44 is formed therebetween having an access opening 46 formed at an uppermost portion thereof (FIG. 3) The vertically extending pocket member 44 is provided with a vertically extending card member 50 (illustrated in dotted) which includes written indicia thereon illustrating the books of the bible in chronological order (not shown) This is provided as a study guide to assist a user in quickly accessing particular parts of the bible.

The binder 10 is also provided with a second upper planar member 52 which is coupled in spaced alignment with upper and intermediate portions 54 and 56 respectively of the first upper planar member 20. As a result an upper pocket member 58 is formed between the members 20 and 52 having an access opening 60 formed therein adjacent the vertically extending coupling member 18. The pocket member 52 is provided to support a calendar 61 (illustrated in dotted) therein to assist a user with relevant dates necessary to enhance the religious study experience.

A third upper planar member 62 is provided which is coupled in spaced alignment with intermediate and lower portions 56 and 64, respectively, of the first upper planar member 20 so that a lower pocket member 66 is formed therebetween having an opening 68 formed adjacent the intermediate portions of the first upper planar member The pocket member 62 is provided to carry other relevant items associated with the worship experience such as, for example, offering envelopes.

The binder 10 is also provided with a triangular shaped planar member 70. The triangular shaped planar member 70 is coupled in spaced alignment with lowermost portions 72 of the upper planar member 28 of the back support member 16 As a result, a triangular shaped pocket member 74 is formed between the planar members 28 and 70 having a diagonally extending access opening 76 formed therein. The pocket member 74 is provided for example to carry other relevant study materials that may be used to better understand the bible

The binder 10 is also provided with an intermediate support member, generally designated, by the numeral, 80. The intermediate support member 80 is pivotally coupled to outermost portions 82 of the back support member 16 by a vertically extending coupling member 84. The intermediate support member 80 is pivotably coupled to the back support member 16 so that it can be pivoted to a closed position adjacently aligned with the back support member or to an open position in paralleled alignment therewith. The intermediate support member 80 is provided with upper and lower spaced aligned planar members 84 and 86 respectively The planar members 84 and 86 are coupled together so that a pocket member 90 is formed therebetween having a horizontally extending access opening 92 formed at an uppermost portion 94 thereof The pocket member 90 is provided so that a note pad (not shown) can be carried in the binder 10

An elongated horizontally extending support member, generally designated, by the numeral, 96 is provided having an opening 98 formed therethrough. The support member 96 is formed on the uppermost portion 94 of the intermediate planar member 86.

The support member 96 is provided so that a user may carry a writing instrument (not shown) in the binder 10 such as for example a pen or pencil.

It should be understood that various changes and modifications can be made without departing from the spirit of the invention as defined in the claim.

What is claimed:

1. A binder for supporting a bible therein including
a front support member,
a back support member aligned with and spaced from the front support member;
a vertically extending member for hingedly coupling the front support member to the back support member;
a first pocket member included in the front support member for supporting a front cover of the bible therein,
a second pocket member included in the back support member for supporting a back cover of the bible therein,
a vertically extending member coupled to the front support member having indicia thereon illustrating the chronological order of the books of the bible;
a third pocket member coupled to upper and intermediate inside portions of the front support member;
a fourth pocket member coupled to the intermediate and lower inside portion of the front support member;
a triangularly shaped pocket member coupled to lowermost inside portions of the back support member;
an intermediate support member having innermost portions thereof hingedly coupled to outermost portion of the back support member,
a fifth pocket member coupled to inside portions of the intermediate support member, and
an elongated horizontally extending pocket member coupled to uppermost portions of the intermediate support member

2. A binder as defined in claim 1 wherein the front support member includes:
a first upper member, and
a lower member aligned with and spaced from the first upper member so that the first pocket member is formed therebetween having an access opening formed therein adjacent the vertically extending coupling member

3. A binder as defined in claim 2 wherein the back support member includes:
an upper member; and
a lower member aligned with and spaced from the upper member so that the second pocket member is formed therebetween having an access opening formed therein adjacent the vertically extending coupling member.

4. A binder as defined in claim 3 wherein the front support member further includes a second upper member aligned with and spaced from upper intermediate portions of the first upper member so that the third pocket is formed therebetween having an access opening formed therein.

5. A binder as defined in claim 4 wherein the front support member further includes a third upper member aligned and spaced from intermediate and lower portions of the first upper member so that the fourth pocket is formed therebetween having an access opening formed therein

6. A binder as defined in claim 5 wherein the back support member further includes a triangular shaped upper member aligned with and spaced from the upper member of the back support member so that the triangularly shaped pocket member is formed therebetween having an access opening formed therein

7. A binder as defined in claim 6 further including a vertically extending coupling member for hingedly coupling innermost portions of the intermediate support member to outermost portions of the back support member

8. A binder as defined in claim 7 wherein the intermediate support member further includes
an upper member,
a lower member aligned with and spaced from the upper member so that the fifth pocket member is formed therebetween having an access opening formed therein adjacent upper portions of the upper and lower members
